(19) United States
(12) Patent Application Publication
(10) Pub. No.: US 2023/0193684 A1
(43) Pub. Date: Jun. 22, 2023

(54) OPERATION DETECTION DEVICE FOR VEHICLE AND OPERATION DETECTION METHOD FOR VEHICLE

(71) Applicant: AISIN CORPORATION, Kariya (JP)

(72) Inventors: Takuya TAMURA, Kariya-shi (JP); Keiichi YANAI, Kariya-shi (JP); Eiji ITAMI, Kariya-shi (JP)

(73) Assignee: AISIN CORPORATION, Kariya (JP)

(21) Appl. No.: 18/059,508

(22) Filed: Nov. 29, 2022

(30) Foreign Application Priority Data
Dec. 21, 2021 (JP) 2021-207144

(51) Int. Cl. E05F 15/73; G06V 40/20

(52) U.S. Cl. CPC E05F 15/73; G06V 40/28; E05F 2015/767

(57) ABSTRACT

An operation detection device for a vehicle including a camera that captures an image of a periphery of an opening portion of a vehicle body includes a position determination unit configured to determine whether a first body part and a second body part of a user in the image captured by the camera are present in a user determination area set in the image, a gesture determination unit configured to determine, based on the image captured after it is determined that the first body part and the second body part are present in the user determination area, whether at least one of a first gesture using the first body part and a second gesture using the second body part is made, and an output unit configured to output the trigger signal when it is determined that at least one of the first gesture and the second gesture is made.

### CROSS REFERENCE TO RELATED APPLICATIONS

This application is based on and claims priority under 35 U.S.C. § 119 to Japanese Patent Application 2021-207144, filed on Dec. 21, 2021, the entire content of which is incorporated herein by reference.

### TECHNICAL FIELD

This disclosure relates to an operation detection device for a vehicle and an operation detection method for a vehicle.

### BACKGROUND DISCUSSION

JP 2016-196798A (Reference 1) discloses a vehicle including a vehicle body that is provided with an opening portion, a vehicle gate that opens and closes the opening portion, a gate actuator that drives the vehicle gate, a camera that captures an image of a periphery of the vehicle, and an operation detection device for the vehicle that controls the gate actuator. The operation detection device for the vehicle causes the gate actuator to open the vehicle gate when determining, based on the image captured by the camera, that a user makes a predetermined gesture.

The operation detection device for the vehicle as described above recognizes only a motion of a foot of the user based on the image captured by the camera and determines the motion as the gesture. Therefore, the operation detection device for the vehicle may recognize a nearby person who is not the user, which leaves room for improvement in terms of correctly recognizing a user.

### SUMMARY

According to one aspect of this disclosure, there is provided an operation detection device for a vehicle, which is applied to a vehicle including a vehicle body having an opening portion, an opening and closing body that opens and closes the opening portion, a driving unit that drives the opening and closing body, and a camera that captures an image of a periphery of the opening portion, and which outputs a trigger signal for starting driving of the opening and closing body when a gesture of a user is detected. The operation detection device for a vehicle includes: when a body part of the user is a first body part and a body part different from the first body part is a second body part, a position determination unit configured to determine whether the first body part and the second body part in the image captured by the camera are present in a user determination area set in the image; a gesture determination unit configured to determine, based on the image captured after it is determined that the first body part and the second body part are present in the user determination area, whether at least one of a first gesture using the first body part and a second gesture using the second body part is made; and an output unit configured to output the trigger signal when it is determined that at least one of the first gesture and the second gesture is made.

According to another aspect of this disclosure, there is provided an operation detection method for a vehicle, which is applied to a vehicle including a vehicle body having an opening portion, an opening and closing body that opens and closes the opening portion, a driving unit that drives the opening and closing body, and a camera that captures an image of a periphery of the opening portion, and in which a trigger signal for starting driving of the opening and closing body is output when a gesture of a user is detected. The operation detection method for a vehicle includes: when a body part of the user is a first body part and a body part different from the first body part is a second body part, a position determination step of determining whether the first body part and the second body part in the image captured by the camera are present in a user determination area set in the image; a gesture determination step of determining, based on the image captured after it is determined that the first body part and the second body part are present in the user determination area, whether at least one of a first gesture using the first body part and a second gesture using the second body part is made; and an output step of outputting the trigger signal when it is determined that at least one of the first gesture and the second gesture is made.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic diagram of a vehicle including an operation detection device for a vehicle;

FIG. 2 is an example of an image captured by a camera;

FIG. 3 is an example of an image in which a user who makes a foot gesture appears;

FIG. 4 is an example of an image in which the user who makes a hand gesture appears;

FIG. 5 is an example of an image in which the user who makes a sub-gesture appears;

FIG. 6 is a flowchart showing a flow of processing performed by the operation detection device for a vehicle to determine whether the user makes a gesture;

FIG. 7 is a flowchart showing a flow of foot gesture determination processing;

FIG. 8 is a flowchart showing a flow of hand gesture determination processing; and

FIG. 9 is a flowchart showing a flow of sub-gesture determination processing.

### DETAILED DESCRIPTION

Hereinafter, an embodiment of an operation detection device for a vehicle (hereinafter, also referred to as an “operation detection device”) and an operation detection method for a vehicle (hereinafter, also referred to as an “operation detection method”) will be described with reference to the drawings.

### <Vehicle 10>

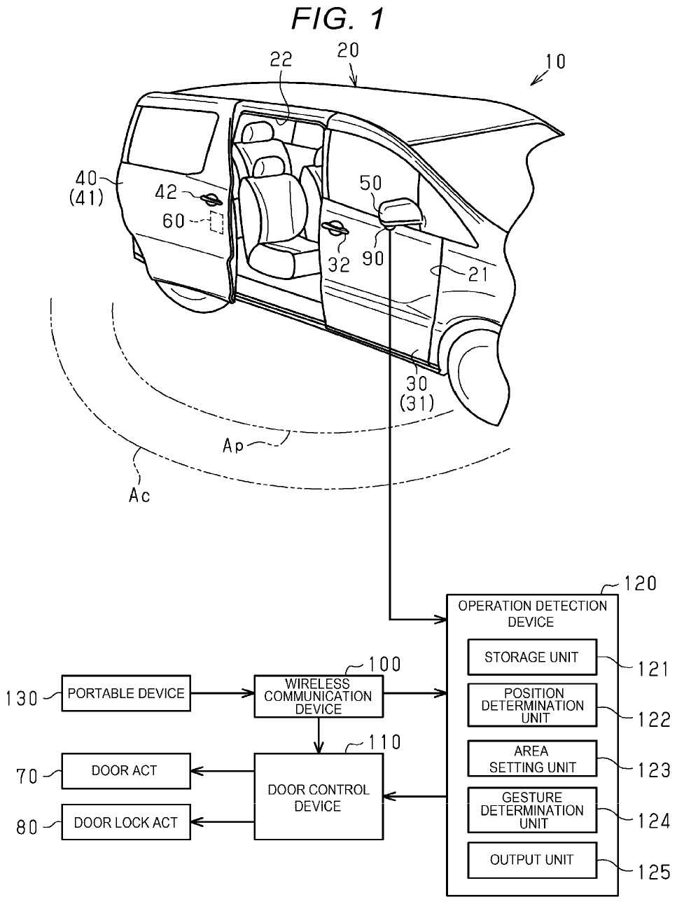

As shown in FIG. 1, a vehicle 10 includes a vehicle body 20, a front door 30, a sliding door 40, a side mirror 50, a lock mechanism 60, a door actuator 70, a door lock actuator 80, and a camera 90. In addition, the vehicle 10 includes a wireless communication device 100, a door control device 110, and an operation detection device 120.

### <Vehicle Body 20>

The vehicle body 20 includes a front opening portion 21 to be opened and closed by the front door 30 and a rear opening portion 22 to be opened and closed by the sliding door 40. The front opening portion 21 and the rear opening portion 22 are portions through which a user passes when moving between an inside and an outside of the vehicle 10. In many vehicles 10, the front opening portion 21 and the rear opening portion 22 are defined by a B-pillar of the vehicle body 20. The rear opening portion 22 corresponds to an “opening portion”.

### <Front Door 30>

The front door 30 includes a door body 31 and a door knob 32 provided on the door body 31. The door knob 32 is a portion that is to be operated when the user opens the front door 30. The front door 30 is displaced between a fully closed position at which the front opening portion 21 is fully closed and a fully open position at which the front opening portion 21 is fully opened by swinging about an axis extending in an up-down direction with respect to the vehicle body 20. The side mirror 50 is attached to a portion near a front end of the front door 30.

### <Sliding Door 40 and Door Actuator 70>

The sliding door 40 includes a door body 41 and a door knob 42 provided on the door body 41. The door knob 42 is a portion that is to be operated when the user opens the sliding door 40. The sliding door 40 is displaced between a fully closed position at which the rear opening portion 22 is fully closed and a fully open position at which the rear opening portion 22 is fully opened by sliding in a front-rear direction with respect to the vehicle body 20. An opening direction of the sliding door 40 is a rearward direction, and a closing direction of the sliding door 40 is a forward direction. The sliding door 40 is opened and closed between the fully closed position and the fully open position by the door actuator 70. In this respect, the sliding door 40 corresponds to an “opening and closing body”, and the door actuator 70 corresponds to a “driving unit”.

### <Lock Mechanism 60 and Door Lock Actuator 80>

The lock mechanism 60 switches between a fully latched state in which the sliding door 40 disposed at the fully closed position is restrained to the vehicle body 20 and an unlatched state in which the sliding door 40 at the fully closed position is released from the restraint with respect to the vehicle body 20. The lock mechanism 60 is shifted from the fully latched state to the unlatched state or from the unlatched state to the fully latched state by the door lock actuator 80. In the following description, a shift of the lock mechanism 60 from the fully latched state to the unlatched state is also referred to as an “unlatching operation”, and a shift of the lock mechanism 60 from the unlatched state to the fully latched state is also referred to as a “fully latching operation”. The door lock actuator 80 corresponds to the “driving unit”.

### <Camera 90>

The camera 90 is installed on the side mirror 50 so as to face downward and rearward. In FIG. 1, only the camera 90 installed on the side mirror 50 on a left side of the vehicle 10 is shown, and the camera 90 is also installed on the side mirror 50 on a right side. As shown in FIG. 1, an imaging area Ap of the camera 90 includes an area of a periphery of the rear opening portion 22. An angle of view of the camera 90 is preferably a wide angle. The camera 90 outputs a captured image to the operation detection device 120 for each frame. As the camera 90, for example, a periphery monitoring device for autonomous driving and a camera that captures an image to be displayed on a 360-degree monitor may be used.

### <Wireless Communication Device 100 and Portable Device 130>

A portable device 130 includes a switch that is operated during an opening or closing operation or a stop of the sliding door 40. The portable device 130 may be a so-called electronic key, a smartphone, or another communication terminal. The wireless communication device 100 performs wireless communication with the portable device 130 located around the vehicle 10, so as to determine whether the portable device 130 is the portable device 130 associated with the vehicle 10. In this respect, the wireless communication device 100 can determine whether the user carrying the portable device 130 is present in a communication area Ac set around the vehicle 10. The communication area Ac is an area slightly larger than the imaging area Ap.

In the portable device 130, when the switch is operated to operate the sliding door 40, the wireless communication device 100 outputs an opening operation command signal, a closing operation command signal, and a stop command signal to the door control device 110 in accordance with the operated switch. The opening operation command signal is a command signal for opening the sliding door 40, and the closing operation command signal is a command signal for closing the sliding door 40. The stop command signal is a command signal for stopping the sliding door 40 during the opening or closing operation. When the portable device 130 is present in the communication area Ac, the wireless communication device 100 outputs a signal indicating that the portable device 130 is present in the communication area Ac to the operation detection device 120.

### <Door Control Device 110>

The door control device 110 controls the door actuator 70 and the door lock actuator 80 based on contents of the received command signal. Specifically, when the opening operation command signal is received, the door control device 110 causes the lock mechanism 60 to perform the unlatching operation, and then causes the sliding door 40 to open. When the closing operation command signal is received, the door control device 110 causes the sliding door 40 to be closed near the fully closed position, and then causes the lock mechanism 60 to perform the fully latching operation. When the stop command signal is received, the door control device 110 stops the sliding door 40 in operation.

### <Operation Detection Device 120>

When a gesture made by a user positioned on a side of the vehicle 10 using a body part is detected, the operation detection device 120 outputs, to the door control device 110, a trigger signal for opening or closing the sliding door 40. Gestures according to the present embodiment include a foot gesture using a foot of the user, a hand gesture using a hand of the user, and a sub-gesture using a hand of the user. The foot of the user corresponds to a “first body part” of the user, and the hand of the user corresponds to a “second body part” and a “third body part” of the user, respectively. The foot gesture corresponds to a “first gesture”, and the hand gesture corresponds to a “second gesture”. The trigger signal according to the present embodiment is the opening operation command signal. In other embodiments, the trigger signal may include the closing operation command signal and the stop command signal.

As shown in FIG. 1, the operation detection device 120 includes a storage unit 121, a position determination unit 122, an area setting unit 123, a gesture determination unit 124, and an output unit 125.

### <Storage Unit 121>

The storage unit 121 stores a trained model obtained by machine learning using training data in which an image captured in advance is associated with a foot position Pf and a hand position Ph of the user. That is, the trained model is a model that receives the image captured by the camera 90 as input and outputs the foot position Pf and the hand position Ph of the user in the image. For example, the trained model is created during designing of the vehicle 10, and is written in the storage unit 121 during manufacturing of the operation detection device 120. In the present embodiment, the foot position Pf may be a position of a foot tip, and the hand position Ph may be a position of a hand tip.

Hereinafter, a method of generating the trained model will be described.

The method of generating the trained model includes a preparation step of preparing training data, and a learning step of performing machine learning based on the training data.

The preparation step includes an acquisition step of acquiring images captured in a state in which the user stands in the imaging area Ap under various conditions, and a specifying step of specifying the foot position Pf and the hand position Ph of the user in a plurality of images acquired in the acquisition step.

The acquisition step is performed using, for example, the actual vehicle 10. In the acquisition step, it is preferable to acquire many images captured by changing a condition related to the user and a condition related to an environment around the vehicle 10. In the acquisition step, it is preferable to acquire an image when a direction of the user with respect to the vehicle 10 is different, an image when a physique of the user is different, an image when footwear and clothes of the user are different, an image when personal belongings of the user are different, an image when a direction in which a shadow of the user is formed is different, and the like. In addition, in the acquisition step, it is preferable to acquire an image when brightness around the vehicle 10 is different, such as daytime and nighttime, an image when the weather is different, such as fine weather and rainy weather, an image when a type of the ground on which the vehicle 10 stops is different, such as presence or absence of paving, and the like. Accordingly, it is possible to obtain a trained model that can be applied to various situations, in other words, a trained model having high versatility.

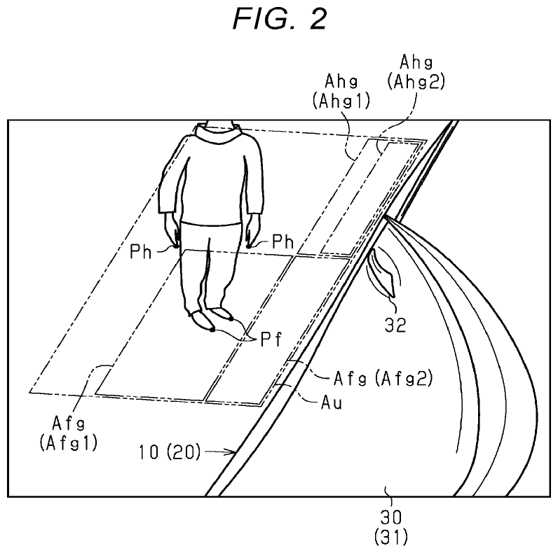

In the specifying step, as indicated by black circles in FIG. 2, the foot positions Pf and the hand positions Ph of the user are specified in the acquired image. For specifying the position, for example, coordinates using pixels in the image may be used. As a result, training data as shown in FIG. 2 is generated.

In the learning step, a model is generated by machine learning using a plurality of pieces of training data as learning data. As a method of machine learning, various methods can be selected, for example, a convolutional neural network (CNN).

When receiving a captured image, the trained model outputs the foot position Pf and the hand position Ph of a person appearing in the image. On the other hand, when an image in which the foot tip and the hand tip of the person do not appear is received, the trained model does not output the foot position Pf and the hand position Ph. The trained model may output the foot position Pf and the hand position Ph of a person who is not a user appearing in the image. That is, as long as a person appears in the image, the trained model outputs the foot position Pf and the hand position Ph of the person even if the person is not the user who intends to make a gesture.

### <Position Determination Unit 122>

When both the foot position Pf and the hand position Ph output by the trained model are present in an area on a side of the vehicle 10, it is highly possible that the user is present on the side of the vehicle 10. On the other hand, when only one of the foot position Pf and the hand position Ph output by the trained model is present in the area on the side of the vehicle 10, it is possible that the user is not present on the side of the vehicle 10. When neither the foot position Pf nor the hand position Ph output by the trained model is present in the area on the side of the vehicle 10, it is highly possible that the user is not present on the side of the vehicle 10. In this way, when only at least one of the foot position Pf and the hand position Ph is present in the image captured by the camera 90, it is highly possible that the foot position Pf and the hand position Ph output by the trained model are not those of the user.

Therefore, the position determination unit 122 acquires the foot position Pf and the hand position Ph in the image by inputting the image captured by the camera 90 into the trained model. Subsequently, the position determination unit 122 determines whether both the foot position Pf and the hand position Ph output by the trained model are present in a user determination area Au set in the area on the side of the vehicle 10. When neither the foot position Pf nor the hand position Ph output by the trained model is present in the user determination area Au, the gesture determination processing to be described later is not performed. As shown in FIG. 2, the user determination area Au is an area set in the image. The user determination area Au has a quadrangular shape, and may have a circular shape or other shapes. The user determination area Au is preferably set as appropriate in accordance with the angle of view of the camera 90 or the like.

The trained model may output only one foot position Pf of the user or may output both foot positions Pf of the user in response to an input of an image in which the user appears. Furthermore, the trained model may output three or more foot positions Pf in response to an input of an image in which a plurality of persons are captured. The same applies to the output of the hand position Ph. In this respect, the position determination unit 122 may determine whether at least one foot position Pf and at least one hand position Ph are present in the user determination area Au. That is, when at least one foot position Pf and at least one hand position Ph are present in the user determination area Au, the position determination unit 122 determines that the user is present on the side of the vehicle 10.

Even when both the foot position Pf and the hand position Ph output by the trained model are present in the user determination area Au, a positional relation between the foot position Pf and the hand position Ph may not be appropriate. In this case, the position determination unit 122 preferably determines that neither the foot position Pf nor the hand position Ph is present in the user determination area Au. The case where the positional relation between the foot position Pf and the hand position Ph is not appropriate is, for example, a case where the foot position Pf is present above the hand position Ph in the image.

### <Gesture Determination Unit 124>

The gesture determination unit 124 performs foot gesture determination processing, hand gesture determination processing, and sub-gesture determination processing. When the position determination unit 122 determines that both the foot position Pf and the hand position Ph output by the trained model are present in the user determination area Au, the gesture determination unit 124 performs the above-mentioned gesture determination processing. When the trained model outputs a plurality of foot positions Pf and a plurality of hand positions Ph, the gesture determination unit 124 preferably performs the above-mentioned gesture determination processing on all the foot positions Pf and the hand positions Ph present in the user determination area Au.

The foot gesture determination processing will be described.

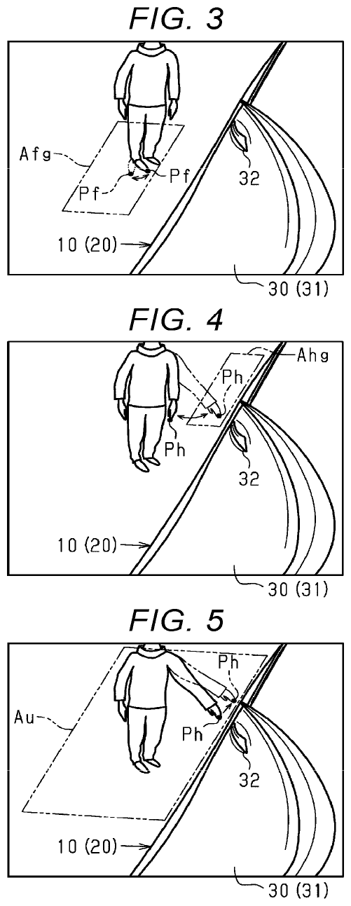

In the foot gesture determination processing, it is determined whether the user makes a foot gesture using a foot in a foot gesture determination area Afg set in the image. As shown in FIG. 3, in the present embodiment, the foot gesture is a motion in which the user swings a right-foot tip so as to draw an arc around a right-foot heel. In other words, the foot gesture is a motion of opening and closing the right-foot tip without changing a position of a right-foot heel.

As shown in FIGS. 2 and 3, the foot gesture determination area Afg is a quadrangular area in the user determination area Au. The foot gesture determination area Afg is an area close to a lower end of the user determination area Au, and is an area close to the vehicle 10. The foot gesture determination area Afg corresponds to a “first area”.

In the foot gesture determination processing, the gesture determination unit 124 calculates a displacement vector of the foot tip of the user based on a plurality of images captured at a time interval. Specifically, the gesture determination unit 124 calculates a displacement vector from a foot position Pf in an N-th image to a foot position Pf in an (N+1)-th image. Here, the N-th image is an image captured by the camera 90 for the N-th time, and the (N+1)-th image is an image captured by the camera 90 for the (N+1)-th time and is an image of a frame after the N-th image. At this time, the gesture determination unit 124 specifies the foot position Pf in the (N+1)-th image corresponding to the foot position Pf in the N-th image by matching feature data of an area including the foot position Pf in the N-th image with respect to the (N+1)-th image. Then, the gesture determination unit 124 calculates a displacement vector of the foot position Pf based on the foot positions Pf in both images. Subsequently, the gesture determination unit 124 calculates a displacement vector from the foot position Pf in the (N+1)-th image to a foot position Pf in an (N+2)-th image. Further, the gesture determination unit 124 calculates a displacement vector from the foot position Pf in the (N+2)-th image to a foot position Pf in an (N+3)-th image.

In this way, the gesture determination unit 124 calculates the displacement vector of the foot position Pf each time a new image is captured. The gesture determination unit 124 may calculate the displacement vector of the foot position Pf each time the camera 90 captures one image, or may calculate the displacement vector of the foot position Pf each time the camera 90 captures a plurality of images. In other words, the gesture determination unit 124 may calculate the displacement vector of the foot position Pf for each frame, or may calculate the displacement vector of the foot position Pf for each of a plurality of frames. A direction of the displacement vector of the foot position Pf indicates a movement direction of the foot tip of the user, and magnitude of the displacement vector of the foot position Pf indicates a movement amount of the foot tip of the user per unit time.

When the direction of the displacement vector of the foot position Pf changes in accordance with a gesture pattern corresponding to the foot gesture, the gesture determination unit 124 determines that a foot gesture is made. The gesture determination unit 124 may alternately or collectively perform calculation of the displacement vector of the foot position Pf and collation of the gesture pattern. In the former case, every time one displacement vector of the foot position Pf is calculated, the gesture determination unit 124 determines whether the direction of the displacement vector is a direction corresponding to the gesture pattern. In the latter case, the gesture determination unit 124 determines whether directions of a plurality of displacement vectors of the foot positions Pf change in the direction corresponding to the gesture pattern after a large number of displacement vectors are calculated. When it is determined that the user makes a foot gesture in the foot gesture determination area Afg, the gesture determination unit 124 outputs a trigger signal to the door control device 110. When the user makes a foot gesture, the direction of the displacement vector of the foot position Pf may change according to the direction of the user. Therefore, the gesture pattern is preferably set according to the direction of the user.

The hand gesture determination processing will be described.

In the hand gesture determination processing, it is determined whether the user makes a hand gesture using a hand in a hand gesture determination area Ahg set in the image. As shown in FIG. 4, in the present embodiment, the hand gesture is a motion in which the hand of the user, which has entered the hand gesture determination area Ahg, exits from the hand gesture determination area Ahg. In other words, the hand gesture is a motion in which the user keeps the hand on the hand gesture determination area Ahg only for a certain period of time.

As shown in FIGS. 2 and 4, the hand gesture determination area Ahg is a quadrangular area in the user determination area Au. The hand gesture determination area Ahg is an area close to an upper end of the user determination area Au, and is an area close to the vehicle 10. The hand gesture determination area Ahg includes an area around the door knob 42 of the sliding door 40. The hand gesture determination area Ahg is smaller than the foot gesture determination area Afg. The hand gesture determination area Ahg corresponds to a “second area”.

In the hand gesture determination processing, when the hand position Ph of the user enters the hand gesture determination area Ahg, the gesture determination unit 124 measures an elapsed time Te from a time when the hand position Ph of the user enters the hand gesture determination area Ahg to a time when the hand position Ph exits from the hand gesture determination area Ahg. When the elapsed time Te is less than an upper limit determination time Tth1 and equal to or longer than a lower limit determination time Tth2, the gesture determination unit 124 determines that the user makes a hand gesture. As an example, the upper limit determination time Tth1 may be set to about 2.0 seconds, and the lower limit determination time Tth2 may be set to about 0.3 seconds. When it is determined that the user makes a hand gesture in the hand gesture determination area Ahg, the gesture determination unit 124 outputs a trigger signal to the door control device 110.

The sub-gesture determination processing will be described.

The sub-gesture determination processing is processing for determining whether the user makes a sub-gesture using a hand in the user determination area Au. As shown in FIG. 5, in the present embodiment, the sub-gesture is a motion in which the user swipes a hand in an opening direction of the sliding door 40.

In the sub-gesture determination processing, the gesture determination unit 124 calculates a displacement vector of the hand tip of the user based on the plurality of images captured at a time interval. Specifically, the gesture determination unit 124 calculates a displacement vector from a hand position Ph in the N-th image to a hand position Ph in the (N+1)-th image. At this time, the gesture determination unit 124 specifies the hand position Ph in the (N+1)-th image by matching feature data of an area including the hand position Ph in the N-th image with respect to the (N+1)-th image. Next, the gesture determination unit 124 calculates a displacement vector of the hand position Ph based on the hand positions Ph in both images. Subsequently, the gesture determination unit 124 calculates a displacement vector from the hand position Ph in the (N+1)-th image to a hand position Ph in the (N+2)-th image. Further, the gesture determination unit 124 calculates a displacement vector from the hand position Ph in the (N+2)-th image to a hand position Ph in the (N+3)-th image.

In this way, the gesture determination unit 124 calculates the displacement vector of the hand position Ph each time a new image is captured. A direction of the displacement vector of the hand position Ph indicates a movement direction of the hand tip of the user, and magnitude of the displacement vector of the hand position Ph indicates a movement amount of the hand tip of the user per unit time.

When the direction of the displacement vector of the hand position Ph changes in accordance with a gesture pattern corresponding to the sub-gesture, the gesture determination unit 124 determines that a sub-gesture is made. The gesture determination unit 124 may alternately or collectively perform calculation of the displacement vector of the hand position Ph and the collation of the gesture pattern. When it is determined that the user makes a third gesture in the user determination area Au, the gesture determination unit 124 outputs a trigger signal to the door control device 110.

As described above, the gesture determination unit 124 determines whether the user makes a gesture based on the plurality of images captured by the camera 90. Therefore, it is preferable that the gesture is a motion that is easily read by the camera 90 regardless of a direction of the body of the user.

### <Area Setting Unit 123>

As shown in FIG. 2, the user determination area Au is an area spreading laterally of the vehicle 10. Therefore, even when both the foot position Pf and the hand position Ph of the user are present in the user determination area Au, a distance between the foot position Pf and the hand position Ph and the vehicle 10 is not always constant. That is, when the user makes a gesture on the side of the vehicle 10, a distance between the user and the vehicle 10 is not always constant. For example, the user may make a gesture at a position slightly away from the vehicle 10, or the user may make a gesture at a position very close to the vehicle 10.

Therefore, the area setting unit 123 adjusts positions of the foot gesture determination area Afg and the hand gesture determination area Ahg in accordance with the foot position Pf when the position determination unit 122 determines that the foot position Pf and the hand position Ph are present in the user determination area Au. That is, the area setting unit 123 adjusts the positions of the foot gesture determination area Afg and the hand gesture determination area Ahg before the gesture determination unit 124 determines whether the gesture is made.

As shown in FIG. 2, in the present embodiment, two candidate areas that are Afg1 and Afg2 are set in the image as candidates for the foot gesture determination area Afg, and two candidate areas that are Ahg1 and Ahg2 are set in the image as candidates for the hand gesture determination area Ahg. The candidate areas Afg1 and Ahg1 are areas assuming that the user is close to the vehicle 10. The candidate areas Afg2 and Ahg2 are areas assuming that the user is very close to the vehicle 10.

As shown in FIG. 2, the candidate areas Afg1 and Afg2 of the foot gesture determination area Afg are adjacent to each other in a width direction of the vehicle 10. The candidate area Afg1 is an area farther from the vehicle 10 than the candidate area Afg2. In other embodiments, candidate areas Afg1 and Afg2 may partially overlap. The candidate area Ahg1 of the hand gesture determination area Ahg is larger than the candidate area Ahg2. Specifically, a length of the candidate area Ahg1 in the width direction of the vehicle 10 is larger than that of the candidate area Ahg2. The candidate area Ahg1 includes the candidate area Ahg2. Right ends of the candidate areas Ahg1 and Ahg2 are aligned with a right end of the user determination area Au. The candidate areas Ahg1 and Ahg2 are located above the candidate areas Afg1 and Afg2. This is because the hand position Ph of the user is above the foot position Pf of the user.

When the foot position Pf is present in the candidate area Afg1 in a case where the position determination unit 122 determines that the foot position Pf and the hand position Ph are present in the user determination area Au, the area setting unit 123 sets the candidate area Afg1 to the foot gesture determination area Afg. In this case, the area setting unit 123 sets the candidate area Ahg1 to the hand gesture determination area Ahg. On the other hand, when the foot position Pf is present in the candidate area Afg2 in the case where the position determination unit 122 determines that the foot position Pf and the hand position Ph are present in the user determination area Au, the area setting unit 123 sets the candidate area Afg2 to the foot gesture determination area Afg. In this case, the area setting unit 123 sets the candidate area Ahg2 to the hand gesture determination area Ahg. Since the hand position Ph is more likely to change than the foot position Pf depending on a posture of the user, in the present embodiment, the foot position Pf is used as a reference for determining a standing position of the user. In other embodiments, the hand position Ph or a position of a body part that is less likely to change may be used as a reference for determining the standing position of the user.

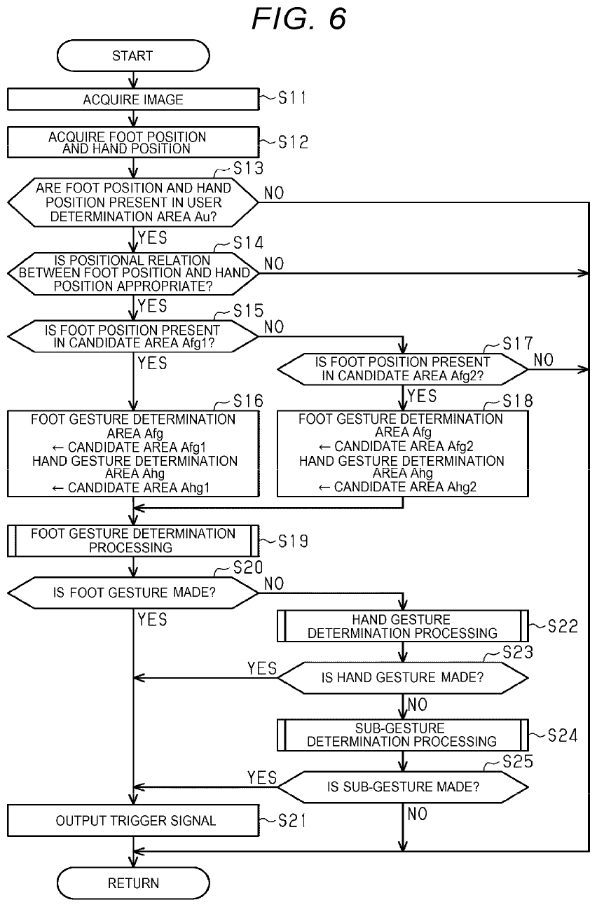

Hereinafter, a flow of processing performed by the operation detection device 120 to detect a gesture of the user will be described with reference to a flowchart shown in FIG. 6. The present processing is started when the user carrying the portable device 130 enters the communication area Ac. When the present processing is started, if the side mirror 50 is folded, the side mirror 50 is deployed so that the camera 90 can capture the user.

As shown in FIG. 6, the operation detection device 120 acquires an image captured by the camera 90 (S11). Subsequently, the operation detection device 120 acquires the foot position Pf and the hand position Ph by inputting the image captured by the camera 90 into the trained model stored in the storage unit 121 (S12). Subsequently, the operation detection device 120 determines whether the acquired foot position Pf and the hand position Ph are present in the user determination area Au (S13). When the foot position Pf and the hand position Ph are not present in the user determination area Au (S13: NO), the operation detection device 120 ends the present processing.

On the other hand, when the foot position Pf and the hand position Ph are present in the user determination area Au (S13: YES), the operation detection device 120 determines whether the positional relation between the foot position Pf and the hand position Ph is appropriate (S14). When the positional relation between the foot position Pf and the hand position Ph is not appropriate (S14: NO), the operation detection device 120 ends the present processing. On the other hand, when the positional relation between the foot position Pf and the hand position Ph is appropriate (S14: YES), the operation detection device 120 determines whether the foot position Pf is present in the candidate area Afg1 (S15). When the foot position Pf is present in the candidate area Afg1 (S15: YES), the operation detection device 120 sets the candidate area Afg1 to the foot gesture determination area Afg and sets the candidate area Ahg1 to the hand gesture determination area Ahg (S16). Subsequently, the operation detection device 120 shifts the processing to the next step S19.

In step S15, when the foot position Pf is not present in the candidate area Afg1 (S15: NO), the operation detection device 120 determines whether the foot position Pf is present in the candidate area Afg2 (S17). When the foot position Pf is not present in the candidate area Afg2 (S17: NO), the operation detection device 120 ends the present processing. On the other hand, when the foot position Pf is present in the candidate area Afg2 (S17: YES), the operation detection device 120 sets the candidate area Afg2 to the foot gesture determination area Afg and sets the candidate area Ahg2 to the hand gesture determination area Ahg (S18).

In step S19, the operation detection device 120 performs the foot gesture determination processing (S19). Subsequently, the operation detection device 120 determines whether a foot gesture is made based on a result of the foot gesture determination processing (S20). When it is determined that the foot gesture is made (S20: YES), the operation detection device 120 outputs a trigger signal to the door control device 110 (S21). Thereafter, the operation detection device 120 ends the present processing.

When it is determined in step S20 that no foot gesture is made (S20: NO), the operation detection device 120 performs the hand gesture determination processing (S22). Subsequently, the operation detection device 120 determines whether a hand gesture is made based on a result of the hand gesture determination processing (S23). When it is determined that the hand gesture is made (S23: YES), the operation detection device 120 shifts the processing to step S21. On the other hand, when it is determined that no hand gesture is made (S23: NO), the operation detection device 120 performs the sub-gesture determination processing (S24). Subsequently, the operation detection device 120 determines whether a sub-gesture is made based on a result of the sub-gesture determination processing (S25). When it is determined that the sub-gesture is made (S25: YES), the operation detection device 120 shifts the processing to step S21. On the other hand, when it is determined that no sub-gesture is made (S25: NO), the operation detection device 120 ends the present processing.

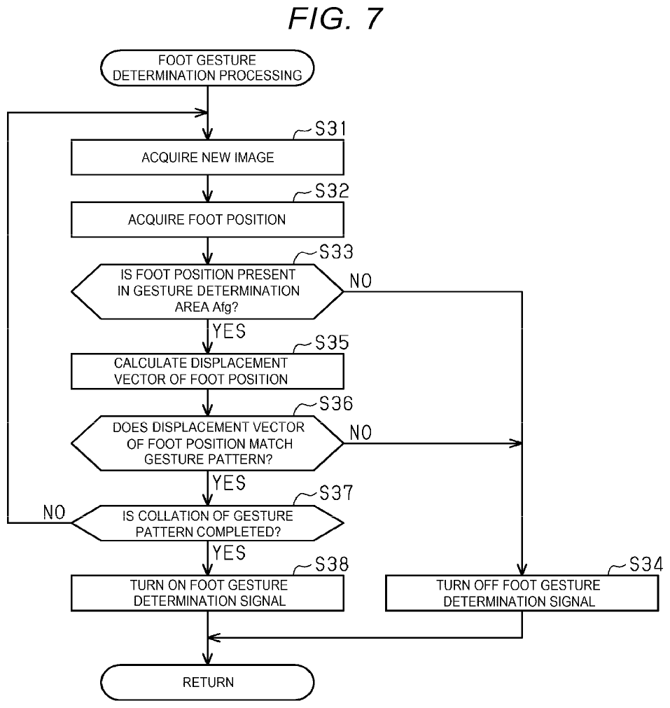

The foot gesture determination processing in step S19 will be described with reference to FIG. 7.

In the foot gesture determination processing, the operation detection device 120 acquires a new image captured by the camera 90 (S31). Subsequently, the operation detection device 120 acquires the foot position Pf by inputting the acquired image into the trained model (S32). Thereafter, the operation detection device 120 determines whether the foot position Pf is present in the foot gesture determination area Afg (S33). When the foot position Pf is not present in the foot gesture determination area Afg (S33: NO), a foot gesture determination signal is turned off (S34). Thereafter, the operation detection device 120 ends the present processing. Here, the foot gesture determination signal is a signal indicating whether a foot gesture is made. The foot gesture determination signal is turned on when it is determined that the foot gesture is made, and is turned off when it is determined that the foot gesture is not made.

In step S33, when the foot position Pf is present in the foot gesture determination area Afg (S33: YES), the displacement vector of the foot position Pf is calculated based on the image captured last time and the image captured this time (S35). Subsequently, the operation detection device 120 determines whether the displacement vector of the foot position Pf matches the gesture pattern (S36). When the displacement vector of the foot position Pf does not match the gesture pattern (S36: NO), the operation detection device 120 shifts the processing to step S34. On the other hand, when the displacement vector of the foot position Pf matches the gesture pattern (S36: YES), the operation detection device 120 determines whether the collation of the gesture pattern is completed (S37). When the collation of the gesture pattern is not completed (S37: NO), the operation detection device 120 shifts the processing to step S31. On the other hand, when the collation of the gesture pattern is completed (S37: YES), the foot gesture determination signal is turned on (S38). Thereafter, the operation detection device 120 ends the present processing.

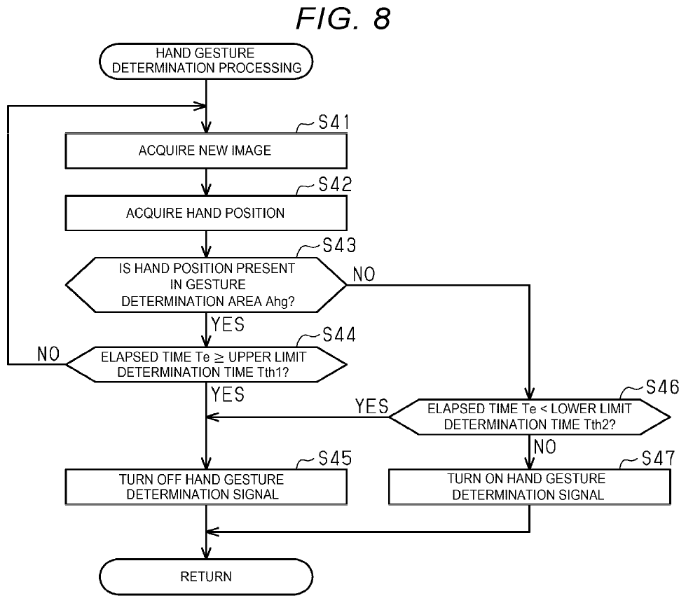

The hand gesture determination processing in step S22 will be described with reference to FIG. 8.

In the hand gesture determination processing, the operation detection device 120 acquires a new image captured by the camera 90 (S41). Subsequently, the operation detection device 120 acquires the hand position Ph by inputting the acquired image into the trained model (S42). Thereafter, the operation detection device 120 determines whether the hand position Ph is present in the hand gesture determination area Ahg (S43). When the hand position Ph is present in the hand gesture determination area Ahg (S43: YES), the operation detection device 120 determines whether the elapsed time Te since the hand position Ph enters the hand gesture determination area Ahg is equal to or longer than the upper limit determination time Tth1 (S44). When the elapsed time Te is equal to or longer than the upper limit determination time Tth1 (S44: YES), in other words, when the hand position Ph of the user remains in the hand gesture determination area Ahg for a long time, the operation detection device 120 turns off the hand gesture determination signal (S45). Thereafter, the operation detection device 120 ends the present processing. Here, the hand gesture determination signal is a signal indicating whether a hand gesture is made. The hand gesture determination signal is turned on when it is determined that the hand gesture is made, and is turned off when it is determined that the hand gesture is not made.

On the other hand, when the hand position Ph is not present in the hand gesture determination area Ahg (S43: NO), the operation detection device 120 determines whether the elapsed time Te since the hand position Ph enters the hand gesture determination area Ahg is less than the lower limit determination time Tth2 (S46). Here, when the hand position Ph does not enter the hand gesture determination area Ahg at all, the elapsed time Te is “0” seconds. When the elapsed time Te is less than the lower limit determination time Tth2 (S46: YES), in other words, when the hand position Ph remains in the hand gesture determination area Ahg only for a very short period of time, the operation detection device 120 shifts the processing to step S45. On the other hand, when the elapsed time Te is equal to or longer than the lower limit determination time Tth2 (S46: NO), the operation detection device 120 turns on the hand gesture determination signal (S47). Thereafter, the operation detection device 120 ends the present processing.

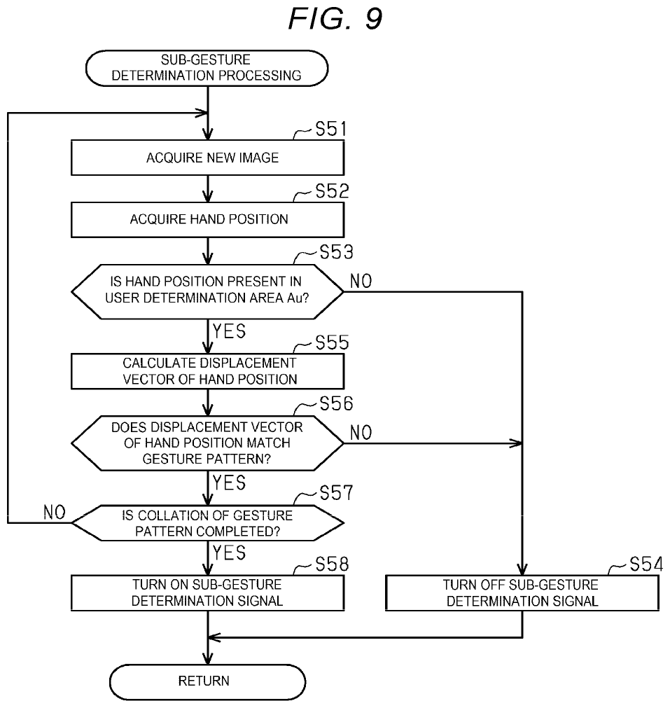

The sub-gesture determination processing in step S24 will be described with reference to FIG. 9.

In the sub-gesture determination processing, the operation detection device 120 acquires a new image captured by the camera 90 (S51). Subsequently, the operation detection device 120 acquires the hand position Ph by inputting the acquired image into the trained model (S52). Thereafter, the operation detection device 120 determines whether the hand position Ph is present in the user determination area Au (S53). When the hand position Ph is not present in the user determination area Au (S53: NO), a sub-gesture determination signal is turned off (S54). Thereafter, the operation detection device 120 ends the present processing. Here, the sub-gesture determination signal is a signal indicating whether a sub-gesture is made. The sub-gesture determination signal is turned on when it is determined that the sub-gesture is made, and is turned off when it is determined that the sub-gesture is not made.

In step S53, when the hand position Ph is present in the user determination area Au (S53: YES), the displacement vector of the hand position Ph is calculated based on the image captured last time and the image captured this time (S55). Subsequently, the operation detection device 120 determines whether the displacement vector of the hand position Ph matches the gesture pattern (S56). When the displacement vector of the hand position Ph does not match the gesture pattern (S56: NO), the operation detection device 120 shifts the processing to step S54. On the other hand, when the displacement vector of the hand position Ph matches the gesture pattern (S56: YES), the operation detection device 120 determines whether the collation of the gesture pattern is completed (S57). When the collation of the gesture pattern is not completed (S57: NO), the operation detection device 120 shifts the processing to step S51. On the other hand, when the collation of the gesture pattern is completed (S57: YES), the sub-gesture determination signal is turned on (S58). Thereafter, the operation detection device 120 ends the present processing.

In the processing described above, steps S12 to S14 correspond to a “position determination step”. Steps S15 to S18 correspond to an “area setting step”. Steps S19, S20, S22 to S25 correspond to a “gesture determination step”. Steps S21 corresponds to an “output step”.

### Function and Effects of Present Embodiment

(1) When both the foot and the hand of the user are present in the user determination area Au, the operation detection device 120 determines whether the foot gesture and the hand gesture are made. Therefore, when there is a high possibility that the user is present near the vehicle 10, it is possible to determine whether the foot gesture and the hand gesture are made. For example, when a person who is not the user is present at a position away from the vehicle 10 and only the foot of the person is present in the user determination area Au, the operation detection device 120 does not determine whether the foot gesture and the hand gesture are made. Therefore, the operation detection device 120 can prevent a motion of a person who is not the user from being determined as a gesture. In this manner, the operation detection device 120 can accurately detect a gesture of the user.

(2) The operation detection device 120 determines, in the foot gesture determination area Afg smaller than the user determination area Au, whether the foot gesture is made. The operation detection device 120 determines, in the hand gesture determination area Ahg smaller than the user determination area Au, whether the hand gesture is made. Therefore, the operation detection device 120 can improve the determination accuracy of a gesture as compared with a case where whether the foot gesture and the hand gesture are made is determined in the user determination area Au.

(3) The operation detection device 120 adjusts positions of the foot gesture determination area Afg and the hand gesture determination area Ahg in accordance with the foot position Pf when it is determined that the foot position Pf and the hand position Ph are present in the user determination area Au. Therefore, the operation detection device 120 can determine whether the foot gesture and the hand gesture are made without excessively increasing the foot gesture determination area Afg and the hand gesture determination area Ahg. As a result, the operation detection device 120 can further improve the determination accuracy of a gesture.

(4) When the user is very close to the vehicle 10, there is a possibility that the hand position Ph when it is determined whether the foot position Pf and the hand position Ph are present in the user determination area Au has already entered the candidate area Ahg1 of the hand gesture determination area Ahg. In this case, when the hand gesture determination area Ahg is set to the candidate area Ahg1, the operation detection device 120 may not successfully detect the hand gesture. In this respect, the operation detection device 120 adjusts the hand gesture determination area Ahg in accordance with the foot position Pf when it is determined that the foot position Pf and the hand position Ph are present in the user determination area Au. Therefore, the operation detection device 120 can prevent a situation in which the hand gesture cannot be detected even though the user is very close to the vehicle 10.

(5) The user can start driving the sliding door 40 by performing a gesture using the foot and the hand that are easy to move. The foot gesture is a motion in which the user moves the foot in the foot gesture determination area Afg, and the hand gesture is a motion in which the hand of the user that has entered the hand gesture determination area Ahg exits from the hand gesture determination area Ahg. Therefore, the operation detection device 120 can make contents of the foot gesture and the hand gesture easy for the user to understand and perform.

(6) The hand gesture is a motion in which the user temporarily brings a hand close to the door knob 42 of the sliding door 40. Therefore, the operation detection device 120 can make the content of the hand gesture natural to the user who intends to open and close the sliding door 40.

(7) The operation detection device 120 also outputs a trigger signal when the user makes a sub-gesture. That is, even in a situation in which the operation detection device 120 is less likely to detect the foot gesture and the hand gesture, the user can drive the sliding door 40 by making the sub-gesture.

### <Modifications>

The present embodiment can be modified and implemented as follows. The present embodiment and the following modifications can be implemented in combination with each other within a range that the embodiment and the modifications do not technically contradict each other.
The hand gesture determination area Ahg may include an area around the door knob 32 of the front door 30. The hand gesture determination area Ahg may include an area around a window glass of the front door 30 or the sliding door 40.
Positions and sizes of the foot gesture determination area Afg and the hand gesture determination area Ahg may be changed as appropriate. For example, the sizes of the foot gesture determination area Afg and the hand gesture determination area Ahg may be equal to a size of the user determination area Au. In other words, the foot gesture determination area Afg and the hand gesture determination area Ahg in the above embodiment may also be implemented as the user determination area Au.
Depending on the content of the foot gesture and the content of the hand gesture, the foot gesture determination area Afg and the hand gesture determination area Ahg may include an area outside the user determination area Au.
The content of the foot gesture and the content of the hand gesture may be changed as appropriate. For example, the foot gesture may be a motion such as stepping. Further, the hand gesture may be a motion such as drawing a circle with a hand.
The first body part, the second body part, and the third body part may be any body part of the user. For example, the first body part may be a head portion of the user, and the second body part may be a waist portion of the user. The third body part may be the same body part as the first body part, or may be a different body part from both the first body part and the second body part.
For example, when the first body part is the head portion of the user, the first gesture may be a motion of turning the head portion up and down or left and right. When the second body part is an arm portion of the user, the second gesture may be a motion of turning the arm portion up and down or left and right.
The trained model may be configured to output positions of other body parts in response to the input of the image. In this case, the position determination unit 122 can acquire, for example, the foot position Pf, the hand position Ph, a position of the head portion, a position of the chest, a position of the shoulder, a position of the waist portion, a position of the elbow, a position of the knee. The position determination unit 122 may determine whether the user is close to the vehicle 10 by determining whether the positions of the plurality of body parts are present in the user determination area Au. As the number of these positions increases, determination accuracy of whether the user is close to the vehicle 10 increases.
The gesture determination unit 124 may not perform one of the foot gesture determination processing and the hand gesture determination processing. That is, in the flowchart shown in FIG. 6, the operation detection device 120 may not perform the processing in steps S19 and S20 or the processing in steps S22 and S23.
The gesture determination unit 124 may not perform the sub-gesture determination processing. That is, in the flowchart shown in FIG. 6, the operation detection device 120 may not perform the processing in steps S24 and S25.
When it is determined that both the foot gesture and the hand gesture are made, the gesture determination unit 124 may output a trigger signal.
The operation detection device 120 may not include the area setting unit 123. That is, in the flowchart shown in FIG. 6, the operation detection device 120 may not perform the processing in steps S15 to S18. In this case, the foot gesture determination area Afg is preset. For example, the foot gesture determination area Afg may be an area obtained by adding the candidate area Afg1 and the candidate area Afg2. The same applies to the hand gesture determination area Ahg.
Three or more candidate areas of the foot gesture determination area Afg may be present in the image. In this case, the area setting unit 123 may select a candidate area to be the foot gesture determination area Afg from the three or more candidate areas. The same applies to the hand gesture determination area Ahg.
The area setting unit 123 may set, as the foot gesture determination area Afg, an area of a predetermined size centered on the foot position Pf when it is determined that the foot position Pf and the hand position Ph are present in the user determination area Au. The same applies to the hand gesture determination area Ahg.
The output unit 125 may output trigger signals having different contents according to contents of gestures. According to this, the user can drive the sliding door 40 in a different mode according to the contents of the gestures to be made.
The vehicle 10 may include a seat, a seat actuator that adjusts a position of the seat, and a seat control device that controls the seat actuator. In this case, the operation detection device 120 may transmit a trigger signal to the sheet control device when a gesture of the user is detected. Further, when receiving the trigger signal, the seat control device may drive the seat actuator such that the seat is disposed at a predetermined position.
The operation detection device 120 may detect a gesture of the user for closing the sliding door 40. In this case, a gesture for opening the sliding door 40 and the gesture for closing the sliding door 40 may be the same as or different from each other.
When receiving an opening operation command signal as a trigger signal from the operation detection device 120, the door control device 110 may only cause the lock mechanism 60 to perform an unlatching operation.
The camera 90 may not be installed on the side mirror 50. For example, the camera 90 may be installed at an upper end of the rear opening portion 22, or may be installed on the sliding door 40.
An “opening and closing body” may be the front door 30, a back door, or a movable panel of a sunroof device.
The door control device 110 and the operation detection device 120 may be configured as one or more processors that operate in accordance with a computer program (software). In addition, the door control device 110 and the operation detection device 120 may be configured as one or more dedicated hardware circuits such as dedicated hardware (application specific integrated circuit (ASIC)) that executes at least a part of various processing. Further, the door control device 110 and the operation detection device 120 may be configured as a circuit including a combination thereof. The processor includes a CPU and a memory such as RAM and ROM. The memory stores a program code or a command configured to cause the CPU to execute processing. The memory, that is, a storage medium includes any available medium that can be accessed by a general-purpose or dedicated computer.

According to one aspect of this disclosure, there is provided an operation detection device for a vehicle, which is applied to a vehicle including a vehicle body having an opening portion, an opening and closing body that opens and closes the opening portion, a driving unit that drives the opening and closing body, and a camera that captures an image of a periphery of the opening portion, and which outputs a trigger signal for starting driving of the opening and closing body when a gesture of a user is detected. The operation detection device for a vehicle includes: when a body part of the user is a first body part and a body part different from the first body part is a second body part, a position determination unit configured to determine whether the first body part and the second body part in the image captured by the camera are present in a user determination area set in the image; a gesture determination unit configured to determine, based on the image captured after it is determined that the first body part and the second body part are present in the user determination area, whether at least one of a first gesture using the first body part and a second gesture using the second body part is made; and an output unit configured to output the trigger signal when it is determined that at least one of the first gesture and the second gesture is made.

When the first body part and the second body part are present in the user determination area, the operation detection device for a vehicle determines whether the first gesture and the second gesture are made. Therefore, when there is a high possibility that the user is present near the vehicle, it is possible to determine whether the first gesture and the second gesture are made. For example, when a person who is not the user is present at a position away from the vehicle and only one of the first body part and the second body part of the person is present in the user determination area, the operation detection device for a vehicle does not determine whether the first gesture and the second gesture are made. Therefore, the operation detection device for a vehicle can prevent a motion of a person who is not the user from being determined as a gesture. In this manner, the operation detection device for a vehicle can accurately detect a gesture of the user.

In the operation detection device for a vehicle, the gesture determination unit may determine whether the first gesture is made in a first area set in the image, and determine whether the second gesture is made in a second area set in the image, and in the image, the first area and the second area may be smaller than the user determination area.

The operation detection device for a vehicle performs, in the first area smaller than the user determination area, determination of whether the first gesture is made, and performs, in the second area smaller than the user determination area, determination of whether the second gesture is made. Therefore, the operation detection device for a vehicle can improve determination accuracy of a gesture as compared with a case where whether the first gesture and the second gesture are made is determined in the user determination area.

The operation detection device for a vehicle may further include an area setting unit configured to adjust a position of the first area and a position of the second area in accordance with a position of at least one of the first body part and the second body part when it is determined that the first body part and the second body part are present in the user determination area.

The user may make a gesture at a position slightly away from the vehicle, or may make a gesture at a position very close to the vehicle. In this respect, when the user makes a gesture, the first body part and the second body part of the user with respect to the vehicle are less likely to be fixed at certain positions. In this respect, since the operation detection device for a vehicle adjusts the positions of the first area and the second area, it is not necessary to enlarge the first area and the second area. As a result, the operation detection device for a vehicle can further improve the determination accuracy of a gesture.

In the operation detection device for a vehicle, the first gesture may be a motion of moving a foot as the first body part in the first area, and the second gesture may be a motion of causing a hand as the second body part to enter the second area and then exit from the second area.

The user can start driving the opening and closing body by performing a gesture using the foot and the hand that are easy to move. The operation detection device for a vehicle can make contents of the first gesture and the second gesture easy for the user to understand and perform.

The opening and closing body is a sliding door having a door knob, and in the operation detection device for a vehicle, the second area may include an area around the door knob.

The second gesture is a motion in which the user temporarily brings a hand close to the door knob of the sliding door. Therefore, the operation detection device for a vehicle can make the second gesture natural to the user who intends to drive the opening and closing body.

In the operation detection device for a vehicle, the gesture determination unit may determine, based on the image captured after it is determined that the first body part and the second body part are present in the user determination area, whether a sub-gesture using a third body part, which is a body part of the user, is made, and the output unit may output the trigger signal when the sub-gesture is made.

The operation detection device for a vehicle also outputs a trigger signal when the user makes a sub-gesture. That is, when the operation detection device for a vehicle cannot detect the first gesture and the second gesture, the user can drive the opening and closing body by making the sub-gesture.

According to another aspect of this disclosure, there is provided an operation detection method for a vehicle, which is applied to a vehicle including a vehicle body having an opening portion, an opening and closing body that opens and closes the opening portion, a driving unit that drives the opening and closing body, and a camera that captures an image of a periphery of the opening portion, and in which a trigger signal for starting driving of the opening and closing body is output when a gesture of a user is detected. The operation detection method for a vehicle includes: when a body part of the user is a first body part and a body part different from the first body part is a second body part, a position determination step of determining whether the first body part and the second body part in the image captured by the camera are present in a user determination area set in the image; a gesture determination step of determining, based on the image captured after it is determined that the first body part and the second body part are present in the user determination area, whether at least one of a first gesture using the first body part and a second gesture using the second body part is made; and an output step of outputting the trigger signal when it is determined that at least one of the first gesture and the second gesture is made.

In the operation detection method for a vehicle, functions and effects same as those of the operation detection device for a vehicle described above can be obtained.

The operation detection device for a vehicle and the operation detection method for a vehicle determine whether the foot gesture or the hand gesture is made when it is determined that both the foot and the hand of the user are present in the user determination area in the image captured by the camera. Therefore, it is possible to prevent erroneous recognition of a motion of a person who is not the user, and it is possible to detect a gesture after correctly recognizing the user.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An operation detection device for a vehicle, which is applied to a vehicle including a vehicle body having an opening portion, an opening and closing body that opens and closes the opening portion, a driving unit that drives the opening and closing body, and a camera that captures an image of a periphery of the opening portion, and which outputs a trigger signal for starting driving of the opening and closing body when a gesture of a user is detected, the operation detection device for a vehicle comprising:
when a body part of the user is a first body part and a body part different from the first body part is a second body part,
a position determination unit configured to determine whether the first body part and the second body part in the image captured by the camera are present in a user determination area set in the image;
a gesture determination unit configured to determine, based on the image captured after it is determined that the first body part and the second body part are present in the user determination area, whether at least one of a first gesture using the first body part and a second gesture using the second body part is made; and
an output unit configured to output the trigger signal when it is determined that at least one of the first gesture and the second gesture is made.

2. The operation detection device for a vehicle according to claim 1, wherein
the gesture determination unit determines whether the first gesture is made in a first area set in the image, and determines whether the second gesture is made in a second area set in the image, and
in the image, the first area and the second area are smaller than the user determination area.

3. The operation detection device for a vehicle according to claim 2, further comprising:
an area setting unit configured to adjust a position of the first area and a position of the second area in accordance with a position of at least one of the first body part and the second body part when it is determined that the first body part and the second body part are present in the user determination area.

4. The operation detection device for a vehicle according to claim 2, wherein
the first gesture is a motion of moving a foot as the first body part in the first area, and
the second gesture is a motion of causing a hand as the second body part to enter the second area and then exit from the second area.

5. The operation detection device for a vehicle according to claim 3, wherein
the first gesture is a motion of moving a foot as the first body part in the first area, and
the second gesture is a motion of causing a hand as the second body part to enter the second area and then exit from the second area.

6. The operation detection device for a vehicle according to claim 4, wherein
the opening and closing body is a sliding door having a door knob, and
the second area includes an area around the door knob.

7. The operation detection device for a vehicle according to claim 5, wherein
the opening and closing body is a sliding door having a door knob, and
the second area includes an area around the door knob.

8. The operation detection device for a vehicle according to claim 1, wherein
the gesture determination unit determines, based on the image captured after it is determined that the first body part and the second body part are present in the user determination area, whether a sub-gesture using a third body part, which is a body part of the user, is made, and
the output unit outputs the trigger signal when the sub-gesture is made.

9. The operation detection device for a vehicle according to claim 2, wherein
the gesture determination unit determines, based on the image captured after it is determined that the first body part and the second body part are present in the user determination area, whether a sub-gesture using a third body part, which is a body part of the user, is made, and
the output unit outputs the trigger signal when the sub-gesture is made.

10. The operation detection device for a vehicle according to claim 3, wherein
the gesture determination unit determines, based on the image captured after it is determined that the first body part and the second body part are present in the user determination area, whether a sub-gesture using a third body part, which is a body part of the user, is made, and
the output unit outputs the trigger signal when the sub-gesture is made.

11. The operation detection device for a vehicle according to claim 4, wherein
the gesture determination unit determines, based on the image captured after it is determined that the first body part and the second body part are present in the user determination area, whether a sub-gesture using a third body part, which is a body part of the user, is made, and
the output unit outputs the trigger signal when the sub-gesture is made.

12. The operation detection device for a vehicle according to claim 5, wherein
the gesture determination unit determines, based on the image captured after it is determined that the first body part and the second body part are present in the user determination area, whether a sub-gesture using a third body part, which is a body part of the user, is made, and
the output unit outputs the trigger signal when the sub-gesture is made.

13. The operation detection device for a vehicle according to claim 6, wherein
the gesture determination unit determines, based on the image captured after it is determined that the first body part and the second body part are present in the user determination area, whether a sub-gesture using a third body part, which is a body part of the user, is made, and
the output unit outputs the trigger signal when the sub-gesture is made.

14. The operation detection device for a vehicle according to claim 7, wherein
the gesture determination unit determines, based on the image captured after it is determined that the first body part and the second body part are present in the user determination area, whether a sub-gesture using a third body part, which is a body part of the user, is made, and
the output unit outputs the trigger signal when the sub-gesture is made.

15. An operation detection method for a vehicle, which is applied to a vehicle including a vehicle body having an opening portion, an opening and closing body that opens and closes the opening portion, a driving unit that drives the opening and closing body, and a camera that captures an image of a periphery of the opening portion, and in which a trigger signal for starting driving of the opening and closing body is output when a gesture of a user is detected, the operation detection method for a vehicle comprising:
when a body part of the user is a first body part and a body part different from the first body part is a second body part,
a position determination step of determining whether the first body part and the second body part in the image captured by the camera are present in a user determination area set in the image;
a gesture determination step of determining, based on the image captured after it is determined that the first body part and the second body part are present in the user determination area, whether at least one of a first gesture using the first body part and a second gesture using the second body part is made; and
an output step of outputting the trigger signal when it is determined that at least one of the first gesture and the second gesture is made.
